(19) United States
(12) Patent Application Publication
(10) Pub. No.: US 2010/0303252 A1
(43) Pub. Date: Dec. 2, 2010

(54) DATA RELAY APPARATUS, ACOUSTIC REPRODUCTION SYSTEM AND CONTROL METHOD OF THE SAME

(75) Inventor: Masanobu Funakoshi, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/784,886

(22) Filed: May 21, 2010

(30) Foreign Application Priority Data
Jun. 1, 2009 (JP) 2009-132425

(51) Int. Cl. H04B 3/02

(52) U.S. Cl. 381/80

(57) ABSTRACT

In a system in which a plurality of speakers are connected to an acoustic reproduction apparatus which reproduces an acoustic signal input from an external sound source by transmitting the acoustic signal to each speaker, the acoustic reproduction apparatus transmits a control signal by superimposing the control signal on an acoustic signal to be transmit to each speaker. Each speaker generates a predetermined response signal in accordance with the transmitted control signal. When reproducing the acoustic signal, acoustic control is executed in accordance with the generated response signal.

### BACKGROUND OF THE INVENTION

1. Field of the Invention

The present invention relates to a technique of reproducing an acoustic signal input from an external sound source.

2. Description of the Related Art

Recently, many speaker systems with built-in amplifiers have been placed on the market. A speaker system with a built-in amplifier of this type is connected to an external sound source such as a digital media player (DMP), personal computer (PC), or portable music player for playing back CDs, DVDs, and the like, and reproduces a high-quality sound.

These speaker systems are normally capable of reproducing stereophonic sounds. Except for an integrated housing, however, each individual speaker contains an amplifier for amplifying an acoustic signal.

Accordingly, when comprehensively controlling the volume, quality, and the like of a reproduced sound of the whole system in which each speaker individually amplifies an acoustic signal, a control signal must be transmitted to each speaker.

In any of these conventional systems, therefore, speakers for reproducing individual channels and a controller integrated with or separated from these speakers must be connected by acoustic signal lines to transmit acoustic signals input to the controller to the individual speakers. In addition, it is necessary to connect control signal lines to transmit control signals from the controller to the individual speakers.

Unfortunately, it is troublesome to connect the control signal lines in addition to the acoustic signal lines between the controller and speakers because wiring is complicated.

Accordingly, a technique by which a controller transmits a control signal to a speaker by superimposing the control signal on an acoustic signal has been proposed. That is, a technique has been disclosed by which when serially transmitting a digital acoustic signal by light or the like, reproduction control signals are multiplexed on the digital acoustic signal, and the receiving side reproduces the digital acoustic signals in accordance with the multiplexed reproduction control signal (see, for example, Japanese Patent Laid-Open No. 11-122169).

Unfortunately, serial transmission disclosed in the above-mentioned prior art is one-way communication. Therefore, it is possible to transmit a control signal from the controller to the speaker, but the controller cannot detect the type, operating state, and the like of the speaker as a connection destination.

Accordingly, when designing an acoustic reproduction system in which various speakers different in performance and/or type are connected to the same controller, it is impossible to perform acoustic control by taking account of the characteristics and states of the speakers.

### SUMMARY OF THE INVENTION

The present invention provides an apparatus and method capable of executing acoustic control in accordance with a response signal from a speaker without adding any new hardware.

According to one aspect of the present invention, there is provided a data relay apparatus for relaying a data signal input from an external sound source by transmitting the data signal to a plurality of speakers, comprising: a transmission unit that transmits a control signal by superimposing the control signal on a data signal to be transmitted to the plurality of speakers; a pick-up unit that picks up response signals generated by the plurality of speakers in accordance with the control signal transmitted by the transmission unit; and an execution unit that executes control when relaying the data signal, in accordance with the response signals picked up by the pick-up unit.

According to another aspect of the present invention, there is provided an acoustic reproduction system comprising: the data relay apparatus of claim 1; and a plurality of speakers, which speakers comprises: a generation unit that generates predetermined response signals from the plurality of speakers in accordance with the control signal transmitted from the transmission unit; wherein the pick-up unit picks up the response signals generated by the generation unit.

According to still another aspect of the present invention, there is provided a control method of an control method of a data relay apparatus which relays a data signal input from an external sound source by transmitting the data signal to a plurality of speakers, comprising: transmitting a control signal by superimposing the control signal on a data signal to be transmitted to the plurality of speakers; picking up response signals generated by the plurality of speakers in accordance with the control signal transmitted in the transmitting step; and executing control when relaying the data signal, in accordance with the response signals picked up in the picking up step.

According to still another aspect of the present invention, there is provided a control method of an acoustic reproduction system in which a plurality of speakers are connected to a data relay apparatus which relays a data signal input from an external sound source by transmitting the data signal to the plurality of speakers, comprising: the control method of claim 9; and generating predetermined response signals at the plurality of speakers in accordance with the control signal transmitted in the transmitting step, wherein the picking up step is for picking up the response signals generated in the generating step.

Further features of the present invention will become apparent from the following description of exemplary embodiments (with reference to the attached drawings).

### BRIEF DESCRIPTION OF THE DRAWINGS

FIG. 1 is a view showing an example of the configuration of an acoustic reproduction system according to an embodiment;

FIG. 2 is a view showing an example of the arrangement of an acoustic reproduction apparatus according to the embodiment;

FIG. 3 is a view showing an example of the arrangement of a speaker according to the embodiment;

FIG. 4 is a view showing the sequence of an initialization process according to the embodiment; and

FIG. 5 is a view showing the sequence of an acoustic control process according to the embodiment.

### DESCRIPTION OF THE EMBODIMENTS

An embodiment for carrying out the invention will be explained in detail below with reference to the accompanying drawings.

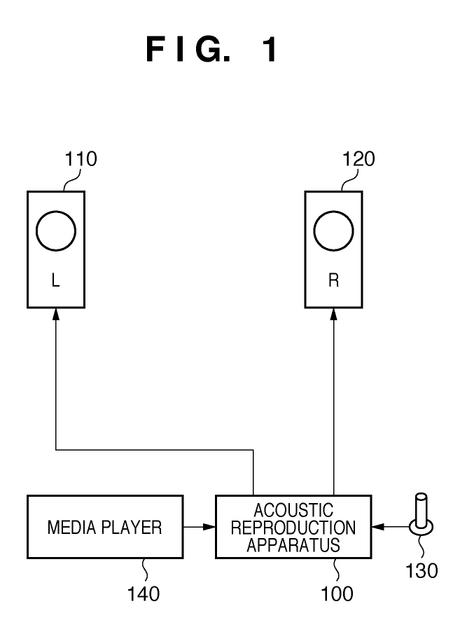

FIG. 1 is a view showing an example of the configuration of an acoustic reproduction system according to this embodiment. This acoustic reproduction system includes an acoustic reproduction apparatus (controller) 100, speakers 110 and 120, a microphone 130, and a media player 140. The speaker 110 is a speaker for the left (L) channel, and the speaker 120 is a speaker for the right (R) channel.

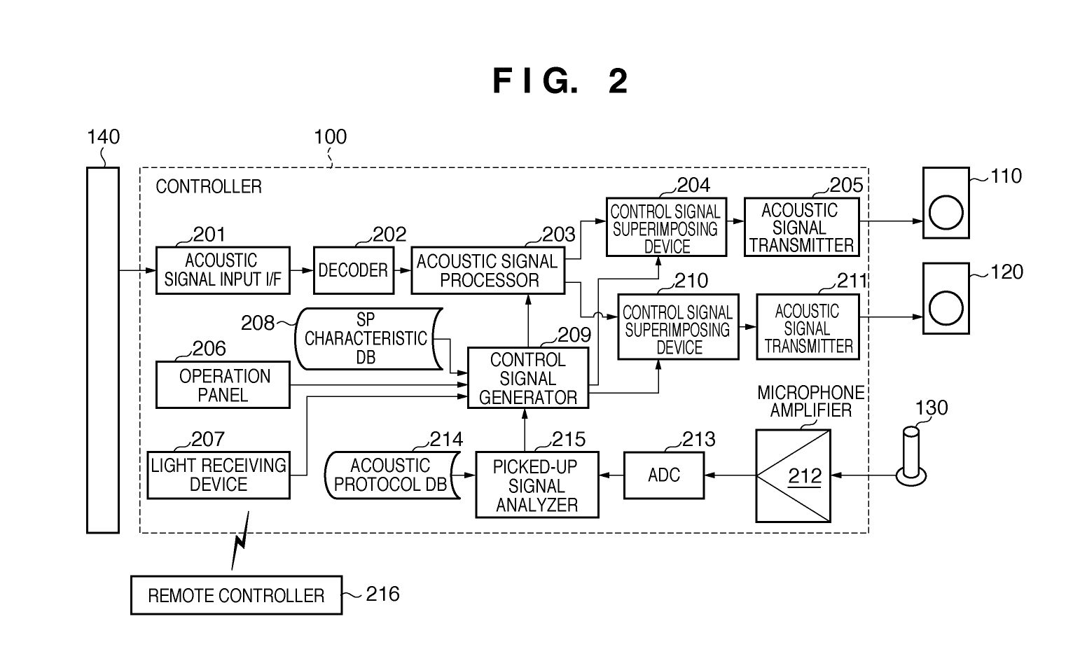

The controller 100 appropriately processes an acoustic signal input from the media player 140 as an external sound source, superimposes control signals on acoustic signals of the left and right channels, and transmits the acoustic signals to the speakers 110 and 120. Note that details of the arrangement of the controller 100 will be described later with reference to FIG. 2.

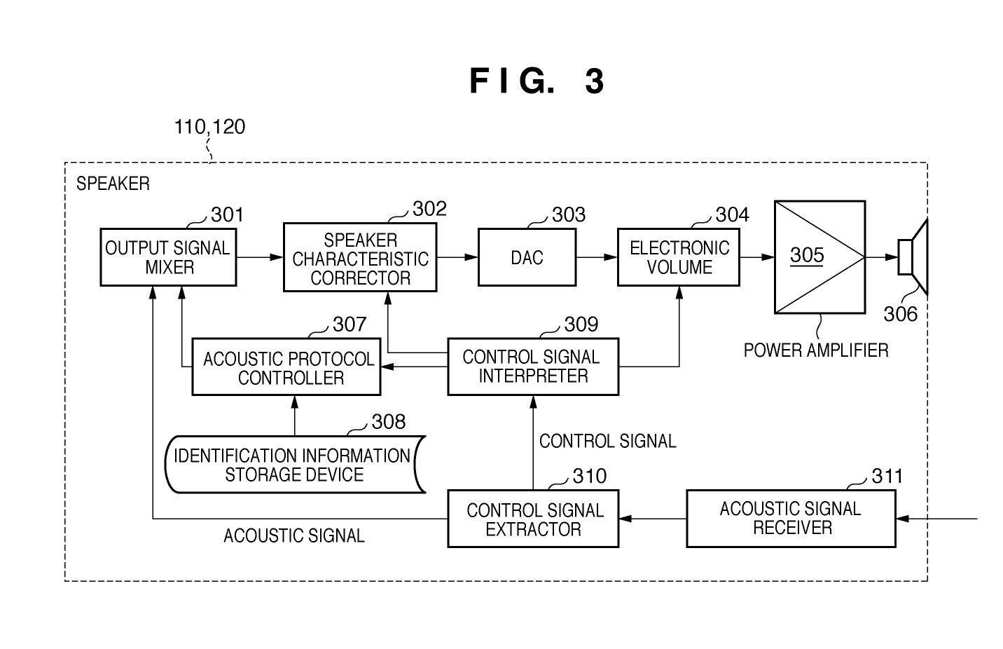

The speakers 110 and 120 reproduce the acoustic signals of the left and right channels transmitted from the controller 100, in accordance with the control signals superimposed on the acoustic signals. Note that the internal constituent elements will be further described later with reference to FIG. 3.

The microphone 130 picks up the acoustic signals generated from the speakers 110 and 120, and outputs the acoustic signals to the controller 100. The media player 140 reproduces digital (electrical or electromagnetic) signals recorded on a CD, DVD, or the like, and outputs the reproduced signals to the controller 100. The controller relays the signals (electrical or electromagnetic) to the speakers 110 and 120.

The details of the arrangement of the acoustic reproduction apparatus (controller or data relay apparatus) 100 shown in FIG. 1 will now be explained with reference to FIG. 2.

FIG. 2 is a view showing an example of the arrangement of the acoustic reproduction apparatus according to this embodiment. Referring to FIG. 2, an acoustic signal input interface (I/F) 201 receives a digital acoustic signal transmitted from the media player 140. Note that the explanation will be made by taking, as an example, the reception of a digital acoustic signal from the media player 140 as an external sound source, but the present invention is not limited to this. As an example, even when receiving an analog acoustic signal, the same processing as in this embodiment can be performed without departing from the scope of the invention.

A decoder 202 decodes the input digital acoustic signal if the signal is an encoded signal, and passes through the input digital acoustic signal if not. An acoustic signal processor 203 performs various types of acoustic signal processing such as various filtering processes, a delaying process, a down-mixing process, and a sound field generating process.

Control signal superimposing devices 204 and 210 for the left and right channels individually superimpose control signals on left and right acoustic signals. Acoustic signal transmitters 205 and 211 for the left and right channels individually transmit the left and right acoustic signals to the speakers 110 and 120.

An operation panel 206 transmits a user command corresponding to an operation performed by a user to a control signal generator 209. A light receiving device 207 converts an optical signal transmitted from a remote controller 216 by optical communication into an electrical signal, and transmits the signal to the control signal generator 209.

A speaker characteristic database (SP characteristic DB) 208 is a database by which various acoustic characteristics of speakers can be checked by performing search based on the type of speaker. The control signal generator 209 generates control signals for the individual constituent elements in accordance with user commands received from the operation panel 206 or light receiving device 207. Also, the control signal generator 209 determines the types of speakers based on response signals picked up from the speakers 110 and 120 by the microphone 130.

A microphone amplifier 212 receives the picked-up signal obtained by the microphone 130, and amplifies the signal. An analog-to-digital converter (ADC) 213 converts the picked-up signal input from the microphone amplifier 212 into a digital acoustic signal by analog-to-digital conversion.

An acoustic protocol database (DB) 214 stores predetermined acoustic protocols in this embodiment. A picked-up signal analyzer 215 analyzes the picked-up signal input from the ADC 213, interprets an acoustic protocol from the picked-up signal by referring to the acoustic protocol DB 214, and converts the picked-up signal into a control signal.

When operated by the user, the remote controller 216 transmits, to the controller 100, various user commands for the controller 100 as optical signals. Note that the remote controller 216 can use not only infrared communication but also near field wireless communication.

The arrangement of the speakers 110 and 120 for reproducing acoustic signals in accordance with control signals superimposed on the acoustic signals by the controller 100 will be explained below with reference to FIG. 3.

FIG. 3 is a view showing an example of the arrangement of the speaker according to this embodiment.

An output signal mixer 301 appropriately switches or mixes an acoustic signal input from a control signal extractor 310 and an acoustic protocol input from an acoustic protocol controller 307, and outputs the obtained signal to a speaker characteristic corrector 302.

The speaker characteristic corrector 302 corrects the speaker characteristics such as the frequency characteristic and phase with respect to the acoustic signal input from the output signal mixer 301, in accordance with a control signal input from a control signal interpreter 309, and outputs the corrected signal to a digital-to-analog converter (DAC) 303. The DAC 303 performs digital-to-analog conversion on the digital acoustic signal input from the speaker characteristic corrector 302, and outputs an analog acoustic signal to an electronic volume 304.

The electronic volume 304 amplifies the input analog acoustic signal in accordance with an amplification amount input from the control signal interpreter 309. A power amplifier 305 amplifies the input analog acoustic signal by a predetermined amplification factor. A diaphragm 306 generates an actual sound by converting the analog acoustic signal from the power amplifier 305 into a physical vibration. The acoustic protocol controller 307 forms a combination of predetermined acoustic protocols in accordance with the control signal from the control signal interpreter 309, and outputs the combination as a response signal.

An identification information storage device 308 is a memory storing data of a signal for identifying the speaker 110 (120). The control signal interpreter 309 interprets a control signal input from the control signal extractor 310, converts the control signal into control signals for the individual constituent elements of the speaker 110 (120), and transmits the control signals. The control signal extractor 310 extracts a control signal from an acoustic signal input from an acoustic signal receiver 311.

The acoustic signal receiver 311 receives an acoustic signal output from the controller 100 to the speaker 110 (120), and converts the received signal into a signal for internal processing.

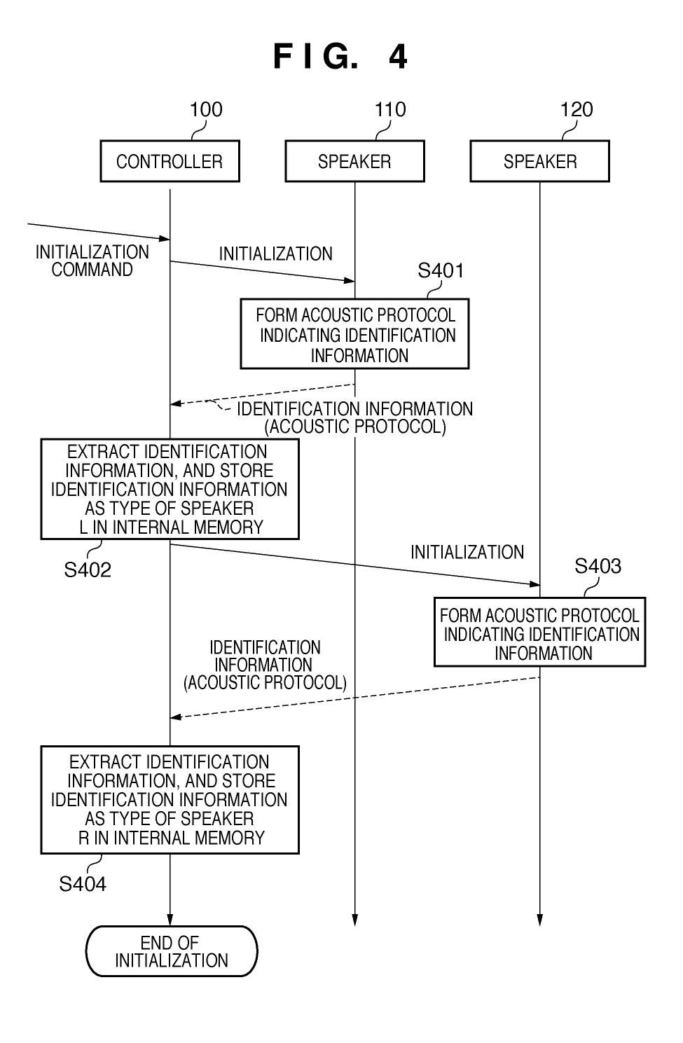

Processing of the acoustic reproduction apparatus (controller) 100 and speakers 110 and 120 in the acoustic reproduction system will be explained below with reference to FIG. 4.

FIG. 4 is a view showing the sequence of an initialization process according to this embodiment. Prior to the process, the control signal generator 209 initializes each unit of the controller 100. This initialization detects whether the left and right speakers 110 and 120 and microphone 130 are physically connected to the controller 100. This connection detecting function is known in this field, so a detailed explanation will be omitted.

The initialization process executed by the controller 100 and speakers 110 and 120 will now be explained. The user outputs an initialization user command to the control signal generator 209 by operating the remote controller 216 or operation panel 206. To transmit an initialization control signal to the speaker 110, the control signal generator 209 outputs an initialization command to the control signal superimposing device 204.

On the other hand, the control signal superimposing device 204 superimposes the initialization command from the control signal generator 209 on an acoustic signal, and outputs the acoustic signal to the acoustic signal transmitter 205. Note that even if no signal is input from the external sound source, when receiving any of various commands from the control signal generator 209, the control signal superimposing device 204 superimposes a control signal on a silent acoustic signal and outputs the acoustic signal.

The acoustic signal on which the control signal is superimposed is transmitted by the acoustic signal transmitter 205, received by the acoustic signal receiver 311 of the speaker 110, and output to the control signal extractor 310. The control signal extractor 310 extracts and separates the superimposed control signal from the transmitted acoustic signal, and outputs the acoustic signal to the output signal mixer 301, and the initialization command as the control signal to the control signal interpreter 309.

When receiving the initialization command, the control signal interpreter 309 instructs the acoustic protocol controller 307 to transmit identification information. The control signal interpreter 309 also operates the electronic volume 304 to perform acoustic reproduction at an appropriate sound pressure. When receiving the instruction from the control signal interpreter 309, the acoustic protocol controller 307 reads out speaker type identification information stored in the identification information storage device 308, converts the identification information into an acoustic protocol (to be described later), and outputs the acoustic protocol to the output signal mixer 301 (S401).

Note that the acoustic protocol in this embodiment may also be the existing acoustic protocol such as a DTMF (Dual-Tone Multi-Frequency) audio signal. It is also possible to use a unique acoustic protocol by which phonemes of a twelve-tone scale are formed based on a phoneme obtained by combining a tone signal having, for example, 440 Hz as the reference tone of A and a plurality of harmonics, and information is transmitted by a simple melody using these phonemes.

Then, the output signal mixer 301 mixes the acoustic protocol indicating the speaker type identification information from the acoustic protocol controller 307 with the silent acoustic signal from the control signal extractor 310, and outputs the mixed acoustic signal. This acoustic signal is transmitted via the speaker characteristic corrector 302, and converted into an analog signal by the DAC 303. The electronic volume 304 amplifies the analog signal to an appropriate amplitude, the power amplifier 305 amplifies the signal, and the diaphragm 306 reproduces the amplified signal as an actual sound.

Subsequently, the microphone 130 picks up the acoustic protocol reproduced as a sound by the speaker 110, and converts the protocol into an analog acoustic signal. The microphone amplifier 212 of the controller 100 amplifies the analog acoustic signal. After that, the ADC 213 converts the amplified analog acoustic signal into a digital acoustic signal, and outputs the signal to the picked-up signal analyzer 215.

The picked-up signal analyzer 215 analyzes the input acoustic signal by referring to the acoustic protocol DB 214, and determines whether an acoustic protocol is contained. If it is determined that an acoustic protocol is contained, the picked-up signal analyzer 215 interprets the acoustic protocol, and outputs the result to the control signal generator 209.

In this embodiment, the picked-up signal analyzer 215 determines by the analysis and interpretation of the acoustic protocol that the acoustic protocol contains the speaker type identification information, and outputs the identification information to the control signal generator 209. The control signal generator 209 determines that the identification information indicates the speaker type of the speaker 110, and stores the information in an internal memory (S402).

Then, the controller 100 transmits the initialization signal to the speaker 120 following the same procedures as for the speaker 110. Consequently, the speaker 120 forms an acoustic protocol indicating the identification information (S403). The controller 100 picks up the acoustic protocol generated by the speaker 120 by the microphone 130, analyzes the protocol, and stores the identification information indicating the speaker type of the speaker 120 in the internal memory of the control signal generator 209 (S404).

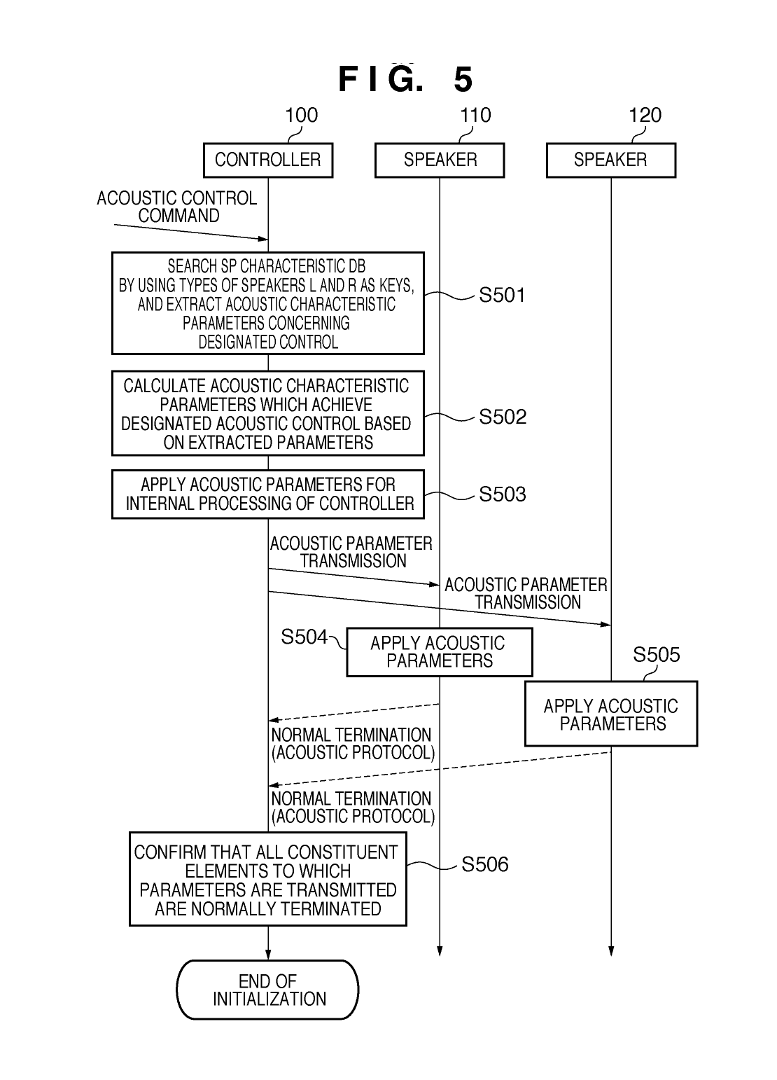

After the above operation, the initialization process is terminated. Next, an acoustic control process according to this embodiment will be explained with reference to FIG. 5.

FIG. 5 is a view showing the sequence of the acoustic control process according to this embodiment. The user outputs various acoustic control instructions to the control signal generator 209 by operating the operation panel 206 or remote controller 216. The control signal generator 209 searches the SP characteristic DB 208 by using, as keys, the speaker types of the speakers 110 and 120 stored in the internal memory. Of the acoustic characteristics of the speakers 110 and 120 found by the search, the control signal generator 209 collects information of characteristics concerning the designated acoustic control, and temporarily stores the information in the memory (S501).

If the user's acoustic control is an instruction to change the frequency characteristic of the speaker, the control signal generator 209 temporarily stores the acoustic characteristic parameters such as the multi-way speaker configuration of each speaker, the reproduction frequency band of each diaphragm, and the crossover frequency in the internal memory.

Then, the control signal generator 209 calculates various acoustic control parameters for achieving the acoustic control designated by the user. In the above-mentioned example, the control signal generator 209 calculates parameters for achieving the designated frequency characteristic change, for example, a tone control parameter for the overall acoustic signal, and a parameter for changing the crossover frequency of each speaker (S502).

Subsequently, the control signal generator 209 outputs the calculated parameters as control signals to the individual constituent elements to be actually controlled (S503). In the above-mentioned example, the control signal generator 209 outputs the tone control parameter for the overall acoustic signal to the acoustic signal processor 203, and the crossover frequency change parameter of each speaker to a corresponding one of the left and right control signal superimposing devices 204 and 210.

On the other hand, the acoustic signal processor 203 changes the tone control of the whole acoustic signal in accordance with the parameters from the control signal generator 209. Also, the control signal transmitted as it is superimposed on the acoustic signal is extracted from the acoustic signal by the control signal extractor 310 of the speaker 110 (120) and interpreted by the control signal interpreter 309, and the crossover frequency change parameter is output to the speaker characteristic corrector 302. In accordance with the parameter, the speaker characteristic corrector 302 changes the crossover frequency (S504 and S505).

Simultaneously with the above-mentioned processing, the control signal interpreter 309 outputs, to the acoustic protocol controller 307, a signal indicating that the processing for the parameter is normally terminated. When receiving this control signal, the acoustic protocol controller 307 forms an acoustic protocol meaning the normal termination, and outputs the protocol to the output signal mixer 301. The output signal mixer 301 mixes the acoustic signal and acoustic protocol, and outputs the mixed acoustic signal. The mixed acoustic signal is transmitted via the speaker characteristic corrector 302, DAC 303, electronic volume 304, and power amplifier 305, generated as a sound from the diaphragm 306, and picked up by the microphone 130.

The picked-up signal analyzer 215 analyzes the picked-up acoustic signal as a digital acoustic signal via the microphone amplifier 212 and ADC 213, thereby extracting and interpreting the acoustic protocol indicating the normal termination. A response signal indicating the normal termination is output to the control signal generator 209, and the control signal generator 209 confirms that the acoustic control is normally done (S506). After the above operation, the acoustic control process is terminated.

In this embodiment, when the controller 100 transmits control signals to the speakers 110 and 120, the speakers 110 and 120 execute operations designated by the control signals. At the end of the operations, the speakers 110 and 120 transmit the operation results on acoustic protocols to the controller 100. Accordingly, this embodiment can reliably control the speakers.

In the initialization process of this embodiment, the left and right speakers connected to the controller each generate the individual identification information indicating the speaker type as an acoustic protocol, and the acoustic protocol is received via the microphone and analyzed. This makes it possible to reveal the speaker type connected to the controller, and grasp details of the speaker acoustic characteristics. In addition, since the performance of the overall system can be grasped by using this information, appropriate acoustic control meeting the system performance can be executed.

Also, the speaker generates an acoustic protocol indicating that acoustic control is normally done, and this acoustic protocol is picked up and analyzed. Therefore, the controller can reliably perform acoustic control on the speaker connected by only an audio interface. Furthermore, if acoustic control is not normally terminated, the speaker can of course generate an acoustic protocol indicating that the acoustic control is not normally terminated.

Accordingly, the acoustic reproduction apparatus can execute acoustic control in accordance with a response signal from the speaker. Also, when receiving a control signal, the speaker converts the prestored individual identification information into an acoustic protocol and generates the acoustic protocol, and the acoustic reproduction apparatus analyzes the acoustic protocol and determines the type of the connected speaker. This makes it possible to change acoustic control in accordance with the speaker type.

In addition, when a control signal contains an instruction to detect the state of heat generation of the power amplifier or diaphragm of the speaker, the operating state of the speaker can be notified by an acoustic protocol. Consequently, acoustic control taking account of the state of the speaker can be performed.

Note that the present invention is not limited to the above-mentioned embodiment. In the above embodiment, the internal processing of the speaker is performed in a digital signal region. However, the difference between a digital signal and analog signal has nothing to do with the scope of the invention. Therefore, the acoustic processing can also be performed in an analog signal region.

By contrast, although signal amplification is performed after DA conversion in this embodiment, a digital signal can also be amplified.

Note also that the controller 100 and microphone 130 are separated devices in the configuration shown in FIG. 1, but the microphone 130 may also be an internal component of the controller 100.

Furthermore, while reproducing normal music, it is also possible to cause the speaker to generate a narrow-band acoustic protocol, and allow the controller to receive this acoustic protocol by performing filtering in the narrow band.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

An embodiment of the invention can provide an acoustic reproduction system in which a plurality of speakers are connected to an acoustic reproduction apparatus which reproduces an acoustic signal input from an external sound source by transmitting the acoustic signal to the plurality of speakers, characterized by comprising: transmission means for transmitting a control signal by superimposing the control signal on acoustic signals to be transmitted from said acoustic reproduction apparatus to the plurality of speakers; generation means for generating predetermined response signals from the plurality of speakers in accordance with the control signal transmitted from said transmission means; pick-up means for picking up the response signals generated by said generation means; and execution means for executing acoustic control when reproducing the acoustic signals, in accordance with the response signals picked up by said pick-up means.

Another embodiment of the invention can provide an acoustic reproduction apparatus which reproduces an acoustic signal input from an external sound source by transmitting the acoustic signal to a plurality of speakers, characterized by comprising: transmission means for transmitting a control signal by superimposing the control signal on acoustic signals to be transmitted to the plurality of speakers; pick-up means for picking up response signals generated by the plurality of speakers in accordance with the control signal transmitted by said transmission means; and execution means for executing acoustic control when reproducing the acoustic signals, in accordance with the response signals picked up by said pick-up means.

Another embodiment of the invention can provide a control method of an acoustic reproduction apparatus which reproduces an acoustic signal input from an external sound source by transmitting the acoustic signal to a plurality of speakers, characterized by comprising: a transmission step of transmitting a control signal by superimposing the control signal on acoustic signals to be transmitted to the plurality of speakers; a pick-up step of picking up response signals generated by the plurality of speakers in accordance with the control signal transmitted in the transmission step; and an execution step of executing acoustic control when reproducing the acoustic signals, in accordance with the response signals picked up in the pick-up step.

Another embodiment of the invention can provide a control method of an acoustic reproduction system in which a plurality of speakers are connected to an acoustic reproduction apparatus which reproduces an acoustic signal input from an external sound source by transmitting the acoustic signal to the plurality of speakers, characterized by comprising: a transmission step of transmitting a control signal by superimposing the control signal on acoustic signals to be transmitted from the acoustic reproduction apparatus to the plurality of speakers; a generation step of generating predetermined response signals from the plurality of speakers in accordance with the control signal transmitted in the transmission step; a pick-up step of picking up the response signals generated in the generation step; and an execution step of executing acoustic control when reproducing the acoustic signals, in accordance with the response signals picked up in the pick-up step.

While the present invention has been described with reference to exemplary embodiments, it is to be understood that the invention is not limited to the disclosed exemplary embodiments. It will of course be understood that this invention has been described above by way of example only, and that modifications of detail can be made within the scope of this invention.

This application claims the benefit of Japanese Patent Application No. 2009-132425, filed Jun. 1, 2009, which is hereby incorporated by reference herein in its entirety.

What is claimed is:

1. A data relay apparatus for relaying a data signal input from an external sound source by transmitting the data signal to a plurality of speakers, comprising:
a transmission unit that transmits a control signal by superimposing the control signal on a data signal to be transmitted to the plurality of speakers;
a pick-up unit that picks up response signals generated by the plurality of speakers in accordance with the control signal transmitted by the transmission unit; and
an execution unit that executes control when relaying the data signal, in accordance with the response signals picked up by the pick-up unit.

2. An acoustic reproduction system comprising:
the data relay apparatus of claim 1; and
a plurality of speakers, which speakers comprises:
a generation unit that generates predetermined response signals from the plurality of speakers in accordance with the control signal transmitted from the transmission unit;
wherein the pick-up unit picks up the response signals generated by the generation unit.

3. The system according to claim 2, wherein, when the control signal designates initialization control, the generation unit generates information for identifying speaker types stored in the plurality of speakers as the response signals.

4. The system according to claim 2, wherein, when the control signal designates acoustic control for changing a frequency characteristic of the speaker, the generation unit generates a result obtained by changing an acoustic characteristic parameter of a speaker as the response signal.

5. The system according to claim 2, wherein, when the control signal designates detection of a state of a speaker, the generation unit generates an operating state of the speaker as the response signal.

6. The system according to claim 2, wherein the pick-up unit picks up the response signals generated from the plurality of speakers by a microphone.

7. The system according to claim 2, wherein the data signal sent between the data relay apparatus and the plurality of speakers is one of an electrical signal, an electromagnetic signal and an optical signal.

8. The system according to claim 2, wherein the response signals between the data relay apparatus and the plurality of speakers are acoustic signals.

9. A control method of a data relay apparatus which relays a data signal input from an external sound source by transmitting the data signal to a plurality of speakers, comprising:
transmitting a control signal by superimposing the control signal on a data signal to be transmitted to the plurality of speakers;
picking up response signals generated by the plurality of speakers in accordance with the control signal transmitted in the transmitting step; and
executing control when relaying the data signal, in accordance with the response signals picked up in the picking up step.

10. A control method of an acoustic reproduction system in which a plurality of speakers are connected to a data relay apparatus which relays a data signal input from an external sound source by transmitting the data signal to the plurality of speakers, comprising:
the control method of claim 9; and
generating predetermined response signals at the plurality of speakers in accordance with the control signal transmitted in the transmitting step,
wherein the picking up step is for picking up the response signals generated in the generating step.

11. A program, which has been stored in a computer-readable storage medium, for causing a computer to execute the control method of a data relay apparatus according to claim 9.

12. A program, which has been stored in a computer-readable storage medium, for causing a computer to execute the control method of an acoustic reproduction system according to claim 10.

13. A computer-readable storage medium recording the program according to claim 11.

14. A computer-readable storage medium recording a program according to claim 12.
